(19) United States
(12) Patent Application Publication
(10) Pub. No.: US 2006/0144454 A1
(43) Pub. Date: Jul. 6, 2006

(54) Quarter Turn Bath Spout Diverter

(75) Inventor: Ararat Fred Abramyan, Glendale, CA (US)

Correspondence Address: ARARAT FRED ABRAMYAN, 1930 CALLE SIRENA, GLENDALE, CA, 91208, US

(73) Assignee: Ararat Fred Abramyan, Glendale, CA (US)

(21) Appl. No.: 11/308,050

(22) Filed: Mar. 3, 2006

(51) Int. Cl. F16K 5/00

(52) U.S. Cl. 137/887

(57) ABSTRACT

The quarter turn bath spout diverter compromises of a commonly used water spout and a quarter turn ball valve. The water spout consists of a drain opening and a half inch pipe thread female adapter as well as a built in location for the quarter turn ball valve. In the open position, the water flows only through the drain opening of the water spout. In the closed position, the water is diverted from the quarter turn ball valve and does not reach the drain opening. Because of the closed position, there is no place for the water to go, a water pressure is created which in turn diverts the water to the opposite direction of the drain opening, usually to another external water escape such as a shower head.

### BACKGROUND OF THE INVENTION

As shown in FIG. 1-A, a commonly used diverter spout, consisting of a drain pipe 5, a pole 7, a leak proof gasket 8, a seal gasket 62, a drain opening 50, a through hole 53 for receiving the seal gasket 62, a partition wall 52, a clamp 611, a neck 70 used to hold onto the clamp 611 for manual operation notably along the pole 7 where the seal gasket 62 is movable up and down and leans on the partition wall 52 when lowered down or slides into the through hole 53 when pulled up. Looking at FIG. 1-B, when the pole 7 is pulled up, the leak proof gasket 8 and the seal gasket 62 are moved up the partition wall 52 and are received by the through hole 53 to provide a seal, when the drain pipe 5 is filled with water, it then creates a water pressure which holds the seal gasket 62 in place and redirects the water flow to the shower head. Without any water pressure to hold the seal gasket 62 in place, the seal gasket 62 will then slide out of the through hole 53 and will slide down along the partition wall 52, thus allowing water to pour out of the drain opening 50.

The mechanism that is used on the commonly used diverter spout tends to leak. Looking at FIG. 1-B you will see the offset block 61 and the partition wall 52, there is little friction that exists between the offset block 61 and the partition wall 52 when the offset block 61 is moved up or down. When the pole 7 is pulled up, the offset block 61 is retained to cover the through hole 53 solely by water pressure. However, there is a collision force in the water as well as the water pressure not being reliable enough to hold the offset block 61 firmly in place to prevent leakage. Due to these conditions, the offset block 61 is apt to move downward. Having the offset block 61 move downwardly will result in not having the through hole 53 covered completely, thus resulting in a leakage of the drain opening 50.

### BRIEF SUMMARY OF THE INVENTION

It is an object of the present invention to combine two commonly used existing inventions, the water spout and the quarter turn ball valve to form the new quarter turn bath spout diverter. The combinational use of the water spout and the quarter turn ball valve will prevent any leakages after turning the ball valve to the closed position as well as allowing more efficient control of the water pressure. With the commonly used diverter spout, leakage is apt to occur due to its sole reliability on water pressure to remain closed. The leaking water is usually hot and will usually cause people to burn their feet when showering. The use of the quarter turn ball valve in the water spout will not leak because it does not rely on water pressure to remain in the closed position; rather it is manually controlled with just the quarter turn of the knob.

### BRIEF DESCRIPTION OF THE DRAWINGS

FIG. 1-A shows side view of the commonly used diverter spout in the open position.

FIG. 1-B shows a side view of the commonly used diverter spout in the closed position.

FIG. 2-A shows a side view of the quarter turn diverter spout in the open position.

FIG. 2-B shows a side view of the quarter turn diverter spout in the closed position.

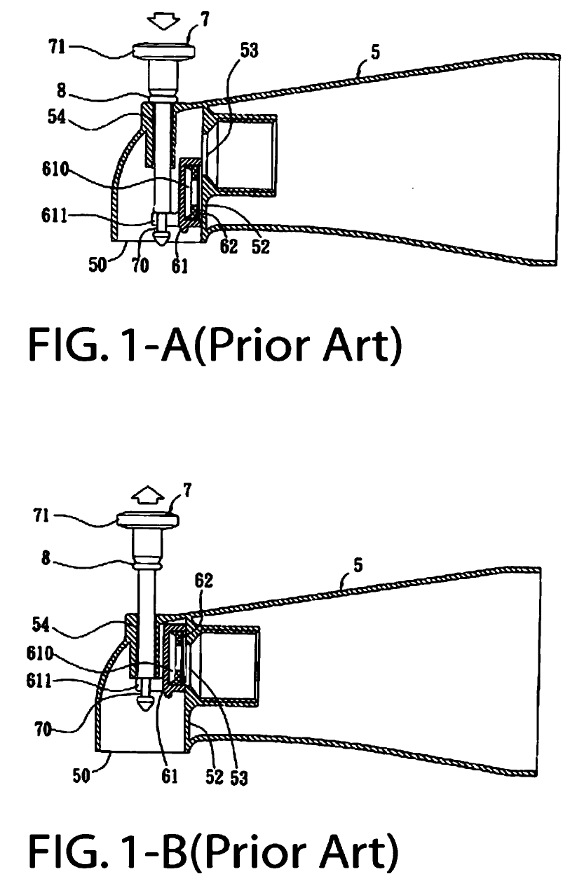

### DETAILED DESCRIPTION OF THE INVENTION

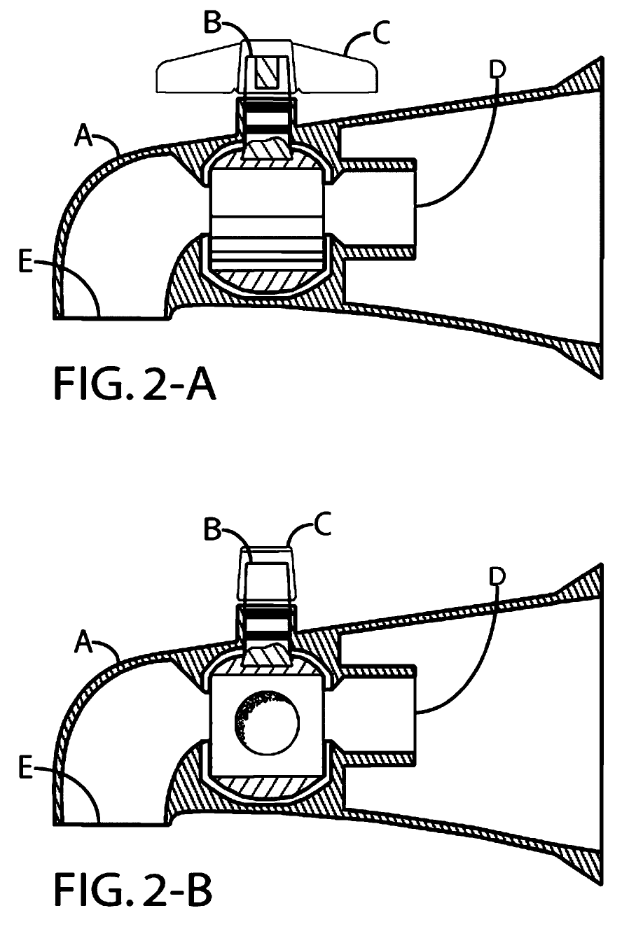

With reference to FIG. 2-A, the quarter turn diverter spout compromises of a water spout A, a quarter turn ball valve B, a knob C used to turn the quarter turn ball valve and a half inch thread female adapter D which is used to connect the quarter turn diverter spout to any existing water pipe. In reference to FIG. 2-A, the knob C and the ball valve B are in the open position, corresponding to each other, which allows the water to flow out of the drain opening E.

Referring to FIG. 2-B, the quarter turn ball valve B is in the closed position because the knob C was quarter turned. Since the ball valve B is now in the closed position, water is diverted from the quarter turn ball valve B and does not reach drain opening E. Because of the closed position of the quarter turn ball valve B, there is no place for the water to go, a water pressure is created in the half inch thread female adapter D as well as the external pipe which it is connected to which in turn diverts the water to the opposite direction of drain opening E, usually to another external water escape such as a commonly used shower head.

What is claimed is:

1. A quarter turn bath spout diverter is a combination of commonly used inventions which are the quarter turn ball valve and water spout used to control and divert water flow to the drain opening or to an external water escape such as a commonly used shower head.
